(19) United States
(12) Patent Application Publication
(10) Pub. No.: US 2007/0028402 A1
(43) Pub. Date: Feb. 8, 2007

(54) Decoration method by anodic oxidation film processing

(75) Inventor: Kazuo Matsuoka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KATSUSHIKA CO., LTD., Tokyo (JP)

(21) Appl. No.: 11/414,387

(22) Filed: May 1, 2006

(30) Foreign Application Priority Data
Aug. 4, 2005 (JP) 2005-226617

(51) Int. Cl. C09B 45/00

(52) U.S. Cl. 8/685

(57) ABSTRACT

In anodic oxidation film processing for expressing pattern by dyeing in two or more colors, the present invention is a method to provide gradation of colors in continuous tones at the gradation portion at the boundary of dyeing. (Problem) To provide a method of realizing at a low cost wear resistant and fading resistant gradation expression on an anodic oxidation film.
(Solution) A part of the decolorize portion 15 having a dyed anodic oxidation film is immersed into a solution of decolorize agent 30 or the solution of decolorize agent 30 is adhered onto the decolorize portion 15. In case of immersing the work 100 into the solution of decolorize agent 30, the solution of decolorize agent 30 and the work 100 are relatively moved up and down or a liquid surface 31 of the solution of decolorize agent 30 is waved for adjustment of decolorizing. Alternatively, in case of adhering the solution of decolorize agent 30 on the work 100, the solution of decolorize agent 30 is sprayed for forming the gradation portion of continuous tones in the degree of dyeing.

### TECHNICAL FIELD

The present invention relates to a decoration method by anodic oxidation film processing, more specifically to a decoration method by an anodic oxidation film for providing patterns of two or more dyeing colors with improved expression ranges by gradation in continuous shades of colors at a gradation portion at the boundary of dyeing.

### BACKGROUND ART

Conventionally, there are many decoration methods to express color patterns of two or more colors on the surface of metal such as aluminum by gradation at the boundary of dyeing. For example, widely known is a decoration method to express gradation by overlapping colors on a base color by spraying or printing.

As a technique for continuously expressing shades of colors by spray painting on aluminum or the like, it is known to use a special spray painting device that enables to diffuse ink in details. On the other hand, there is a method to print by way of a printing original as a method of expressing gradation by painting.

However, such decoration by spray painting or printing causes unevenness on the painting surface because ink is overlapped on the base color before hardening. As a result, the surface is rough and uneven gloss at the gradation portion. Also, cosmetic cases that are carried in a small handbag or the like are tend to wear due to abrasion by hands or surrounding tools, thereby making it difficult to maintain their beauty over a long time.

Now, a gradation expression method to which the present invention relates is disclosed in a Patent Document 1. Disclosed in the Patent Document 1 is an example of means for expressing gradation by superimposing a second paint on a first paint that is coated on a rear surface of a transparent plastic sheet. Also disclosed in a Patent Document 2 is means for expressing characters and/or figures by dyeing with two or more colors on the surface of aluminum processed with anodic oxidation film.

(Patent Document 1) JP2001-149859 A1

(Patent Document 2) JP410-330998 A1

### DISCLOSURE OF THE INVENTION

### Problems to be Solved by the Invention

The above Patent Document 1 is designed to maintain good external visual quality on the painted side even if any paint is painted on the rear surface of a base material. In other words, a printed dyeing layer in a small equilateral hexagonal mesh pattern of opaque dyeing material is provided on the rear surface of a transparent plastic member. In this manner, any trouble or scratch of the gradation expression made by spray painting on the rear side of the printed dyeing layer is made inconspicuous. Also, it is to be noted that any cause of fading of the paint is eliminated and thus quality deterioration in appearance of the gradation expression is effectively avoided because only the front surface is touched by fingers or the like.

However, since the opaque printed dyeing layer in a mesh pattern is distributed uniformly in a manner that can be recognized at a close distance, applications to cosmetic cases or the like in which a special importance is placed on appearance are restricted to those tolerable to such mesh pattern. Moreover, there is a cost problem because the technology to print the mesh pattern requires both of printing and spray painting, thereby increasing the number of steps in decoration processing.

On the other hand, in case of technology as disclosed in the Patent Document 2, an everlasting pattern is formed by combination of coloring by pigment on the surface of aluminum with anodic oxidation film using electrophoresis process or electrolytic dyeing process and a decolorize step. However, in case of applications to cosmetic cases or the like, irregularities in coloring by such electrophoresis process or electrolyte dyeing may be developed on the surface of such cases due to their shapes, thereby making it difficult to achieve uniform coloring. As a result, the number of processing steps increases and thus the production cost increases in case of highly decorative applications.

The present invention was made in consideration of the above problems associated with prior art and it is an object of the present invention to provide a new variation in anode oxidize film processing in continuous shades of decolorize by means of dyeing step and subsequent decolorize step. It is another object of the present invention to provide a less expensive method of realizing degradation expression that is highly resistance to abrasion and fading.

### MEANS TO SOLVE THE PROBLEMS

In order to achieve the above objectives, a first embodiment of the present invention is to immerse a work into a solution of decolorize agent. Additionally, the depth of immersion is sequentially varied to change the time of each part of the work immersed into the solution of decolorize agent, thereby forming a gradation portion having continuous dyeing shades by adjusting the degree of decolorize. It is to be noted herein that the solution of decolorize agent means any solution of oxidizing decolorize agent such as nitric acid, hydrogen peroxide or the like that decomposes the dye for decolorize.

A second embodiment of the present invention is to attach a solution of decolorize agent on a work. And then a solution of decolorize agent is sprayed on the work for forming a gradation portion in continuous grades of decolorize by the solution of the decolorize agent.

Moreover, in the above first and second embodiments, it is preferable to improve adhesion of the solution of decolorize agent on the surface of the work by mixing a viscous adjusting agent in the solution of decolorize agent or by mixing a wetting agent impregnating or attaching the solution of decolorize agent.

### ADVANTAGES OF THE INVENTION

The decoration method by anodic oxidation film processing according to the present invention exhibits the following advantages.

The surface of the aluminum material with the anodic oxidation film processing is wear resistant. As a result, a dyeing agent penetrated into and sealed in small apertures is not decolorized by abrasion of fingers, cloth or other material, thereby forming a stabilized gradation pattern on the surface of aluminum.

Moreover, it is possible to add a new variation of gradation in dyeing of the anodic oxidation film processing by performing gradation at a certain area of the decolorized portion, thereby expanding applications of the anodic oxidation film processing.

Additionally, a dyed work is immersed into a solution of decolorize agent for developing gradation by fading. For this end, the work is moved up and down relative to the liquid surface of the solution of decolorize agent or the liquid surface of the solution of decolorize agent is waved. It is to be noted that a solution of decolorize agent is also adhered onto the work in the present invention. A facility or device required for achieving the above processing in a plant equipped with a decolorize bath for developing various patterns is limited only to a simple device for continuously moving up and down the work within a small distance or a mechanism for waving the liquid surface of the solution of decolorize agent. This means that the gradation expression can be achieved at a low initial cost.

### BEST EMBODIMENTS TO CARRY OUT THE INVENTION

Now, embodiments for embodying the present invention will be described in detail hereunder.

FIG. 1 is a flowchart for the gradation processing according to the present invention. Aluminum in a desired shape by pressing or other processing is transported to an anodic oxidation step 2 after completing a pre-processing step 1 including a surface polishing, a degreasing step, a satin finishing, a frame mounting and the like.

The anodic oxidation step 2 is a step for forming an aluminum anodic oxidation film.

In case of dyeing the aluminum anodic oxidation film, a work 100 passed through the pre-processing step 1 is immersed into a bath of dilute sulfuric acid as an electrolytic solution and electrified by direct current for developing the anodic oxidation film. After forming a predetermined anodic oxidation film, the work 100 is washed with water before being transported to a dyeing step 3.

The dyeing step 3 is a step to dye the anodic oxidation film with a dye of a desired color.

In the dyeing step 3, the work 100 formed with the anodic oxidation film is immersed into a dyeing solution containing a dye for aluminum anodic oxidation film for uniformly dyeing its small apertures. After the dyeing, the work 100 is washed with water and transported to a subsequent decolorize step 4.

The decolorize step 4 is carried out by immersing a decolorize portion of the dyed work 100 into a solution of decolorize agent 30 as shown in FIG. 2, FIG. 3 and the like or by allowing the solution of decolorize agent 30 to adhere onto the decolorize portion 15 of the dyed work 100 as shown in FIG. 4. It is to be noted that the decolorize step 4 is carried out in such a manner that decolorize of the work 100 is to adjust the degree of dyeing of the work 100, thereby developing gradation of dyeing in continuous tones.

The decolorize step 4 for forming gradation is carried out by choosing a part of the work 100 as the decolorize portion 15 and making a part of the decolorize portion 15 in contact with the solution of decolorize agent 30 or departing therefrom. In this manner, formed is a gradation portion 13 in which the degree of dyeing changes in continuous tones.

Now, an additional description of the gradation method according to the present invention will be made hereunder.

FIG. 2 illustrates the case in which the solution of decolorize agent 30 and the work 100 are relatively moved up and down. Such relative up-down movement may be made in two ways: one is to stabilize a liquid surface 31 of the solution of decolorize agent 30 while the work 100 is moved up and down; and the other is to hold still the work 100 while the liquid surface 31 of the solution of decolorize agent 30 is moved up and down. Firstly, a reference will be made to FIG. 2 for describing the former case in which the liquid surface 31 of the solution of decolorize agent 30 is stabilized and the work 100 is moved up and down.

FIG. 2 illustrates a method of forming gradation at a first dyed portion by moving up and down the work 100 with respect to the quiet liquid surface 31. The work 100 is immersed into the solution of decolorize agent 30 to the depth in which the liquid surface 31 is in alignment with the lower end of the gradation portion 13. Such alignment of immersion is only for the purpose of describing the present invention.

It is to be noted here that the decolorize portion 15 is a portion of the work 100 to be immersed into the solution of decolorize agent 30 for decolorizing in the decolorize step 4. The gradation portion 13 is a boundary portion of the work 100 between the decolorize portion 15 that is immersed into the solution of decolorize agent 30 and a non-decolorize portion 11 that is not immersed into the solution of decolorize agent 30 and the gradation portion 13 is repetitively immersed into the solution of decolorize agent 30.

Then, the work 100 immersed into the solution of decolorize agent 30 with the liquid surface 31 in alignment with the low end of the gradation portion 13 is slowly moved up and down in the directions as shown by arrows S1 within the range of the gradation portion 13. The slow up-down movement means that no wave is developed on the liquid surface 31, thereby continuously changing the contact time of the surface of the work 100 and the solution of decolorize agent 30 between the upper end and the lower end of the gradation portion 13. The difference in the contact time of the solution of decolorize agent 30 and the surface of the work 100 realizes gradation in continuous tones due to the difference in the degree of decolorize on the surface of the work 100.

Although it has been described hereinabove that the contact time of the solution of decolorize agent 30 and the surface of the work 100 is continuously changed, it is understood that precisely continuous change may not be necessary if the work 100 is moved up and down in such a manner that no wave is developed in the solution of decolorize agent 30.

Although it has been described in the above description that the work 100 is moved up and down relative to the liquid surface 31, a similar gradation in continuous tones will result by holding still the work 100 and moving up and down the liquid surface 31 of the solution of decolorize agent 30.

In this case, while immersing the work 100 into the solution of decolorize agent 30 with the lower end of the gradation portion 13 in alignment with the liquid surface 31, the liquid surface 31 of the solution of decolorize agent 30 is slowly moved up and down in the directions of arrows S2 within the range of the gradation portion 13.

It is to be noted that the up-down movement of the work 100 may be achieved using means for mechanically moving up and down a mounting jig on which the work 100 is mounted. Alternatively, the up-down movement of the liquid surface 31 may be made using mechanically moving up and down the bath containing the solution of decolorize agent 30 or means for mechanically moving up and down the surface of the liquid within the bath. In this case, it is necessary that the surface of the liquid in the bath remains quiet.

As described hereinabove, the present invention features the relative up-down movement of the solution of decolorize agent 30 and the work 100 due to the up-down movement of the work 100 in the directions of the arrows S1 or the solution of decolorize agent 30 in the directions of the arrows S2.

In this manner, there is formed gradation of the degree of dyeing remaining after the decolorize step in continuous tones at the location between the upper limit and the lower limit of the gradation portion 13 as a result of continuous changes in adhesion time of the solution of decolorize agent 30. This means that decolorize gradation of the gradation portion 13 can be achieved in the work 100 without the need for a special printing technique such as a masking pattern or a spray painting.

FIG. 3 illustrates a second gradation method of the dyed portion by immersing for decolorizing purpose the work 100 into the solution of decolorize agent 30 that waves on the liquid surface 31.

The work 100 is first immersed into the solution of decolorize agent 30 in such a manner that the crest of the waving surface 33 is in alignment with the upper end of the decolorize portion 15. Such alignment of immersion is only for description of the present invention.

It is to be noted herein that the decolorize portion 15 is the portion of the work 100 below the crest of the waving liquid surface 31 in FIG. 3 and is one portion of the work 100 that is decolorized by being immersed into the solution of decolorize agent 30 in the decolorize step 4. On the other hand, the gradation portion 13 is a portion of the work 100 that is repetitively immersed into the solution of decolorize agent 30 between the crest and the bottom of the waving surface 33.

The work 100 that is immersed in aligning the upper end of the decolorize portion 15 with the crest of the waving surface 33 is repetitively exposed to the solution of decolorize agent 30 that is waving with a predetermined crest and the gradation portion 13 is determined continuously at the lower end of the non-decolorize portion 11. As long as the wave of the liquid surface of the solution of decolorize agent 30 is stable at any given point, a stable gradation will develop.

In this way, similarly to the case in FIG. 2, it is possible to develop gradation of colors at the boundary of the decolorize portion of the dyeing agent and the non-decolorize portion by continuously changing the contact time of the solution of decolorize agent 30 and the surface of the work 100 between the upper end and the lower end of the gradation portion 13.

Moreover, in case of developing stable gradation, it is preferable to adjust the increase of viscosity by mixing a viscosity adjusting agent such as thickener, a gelling agent or the like into the solution of decolorize agent 30. Mixing of the viscosity adjusting agent into the solution of decolorize agent 30 increases adhesion of the solution of decolorize agent 30 onto the decolorize portion 15.

Also, it helps to suppress irregular small waves on the liquid surface 31 as a result of interference with the work 100, thereby further enhancing adhesion strength and stabilizing the wetting of the gradation portion 13.

Adjustment of the increase in viscosity increases the internal bonding strength of the solution of decolorize agent 30, prevents the solution of decolorize agent from splashing and also preventing the solution of decolorize agent 30 from attaching to the non-decolorize portion 11.

Although no wave is supposed to develop in the solution of decolorize agent 30 in the first gradation method of the dyed portion as illustrated in FIG. 2, there is developed unavoidable small waves in actual applications due to relative up-down movement of the work 100 and the liquid surface 31. However, the crest of such waves can be suppressed to a low level by the increased internal bonding strength of the solution of decolorize agent 30 as a result of the viscosity adjustment, thereby achieving more stable gradation expression.

As apparent from the above descriptions, if the work 100 is moved up and down on the liquid surface 31 of the solution of decolorize agent 30 or if the liquid surface 31 is waved as shown in FIG. 2 or FIG. 3, the contact time of the solution of decolorize agent 30 and the surface of the work 100 can be controlled to change continuously.

FIG. 4 illustrated a third gradation method of the dyed portion by adhering for decolorizing purpose the solution of decolorize agent 30 on the work 100.

The work 100 is fixed and the solution of decolorize agent 30 is sprayed on the work 100 in form of mist or drops by a sprayer, a spray gun or the like. The sprayed solution of decolorize agent 30 adheres on the surface of the work 100 in a spray painted manner to develop gradation by decolorizing. On the other hand, in case of spraying in drops, the solution of decolorize agent 30 sprayed on the work 100 flows down on the outer surface of the work 100, thereby decolorizing the surface of the work 100.

Preferably, the solution of decolorize agent 30 sprayed on the work 100 by a sprayer, a spray gun or the like is diluted sulfuric acid having oxidation function.

Additionally, in case of spraying on the work 100 in form of drops, it is possible to increase the adhesion strength to the work 100 by mixing thickener or gelling agent with diluted sulfuric acid. As a result, the increased weight of the drops slows down the speed of flowing as compared with the case of spraying only diluted sulfuric acid as the solution of decolorize agent 30 on the work 100, thereby realizing stabilized gradation.

It is also possible to use a particle member in water absorbing sponge form that contains the solution of decolorize agent 30 before being sprayed onto the work 100. In this case, it is possible to achieve the similar effect using less amount of solution of decolorize agent 30. It is also possible to obtain less distinctive gradation boundary.

As described hereinabove, in FIG. 4, distribution of adhesion of the solution of decolorize agent 30 by spraying it on the work 100 using a sprayer, a spray gun or the like causes a continuous change in the degree of decolorize. It is therefore possible to develop gradation at the gradation portion 13.

As understood from the above descriptions with reference to FIGS. 2, 3 and 4, the present invention is effective to easily develop gradation by decolorizing the gradation portion 13 without choosing the dyeing portion by printing such as a masking pattern on the work 100. The work 100 having gradation by decolorizing is transported to an aperture sealing step 5 in FIG. 1 after washing with water.

The aperture sealing step 5 is a step for sealing small apertures in the anodic oxidation film formed on the surface of the dyed work 100. After the aperture sealing step, the work 100 is washed with water and dried to complete the dyeing operation with gradation in the anodic oxidation film.

It is to be noted that, in case of dyeing the work 100 in two or more colors, the work 100 is transported from the decolorize step 4 back to the dyeing step 3 along the dotted arrow 7 in FIG. 1. In other words, after decolorizing and washing with water, the work 100 is transported again to the dyeing step 3 for dyeing the decolorized portion. Such step can be repeated in order to dye in more than two colors.

As apparent from the above descriptions, the decoration method by anodic oxidation film processing according to the present invention enable to provide multi-color dyeing with gradation without using a masking or the like for printing. It is also possible to achieve the advantages as described hereinabove using simple facilities to carry out the present invention.

Although the foregoing descriptions are made on particular embodiments based on the accompanying drawings, it is to be noted that the present invention should not be restricted to the shown embodiments and that various modifications can be made by employing any known construction in order to achieve the advantages of the present invention.

### BRIEF DESCRIPTION OF THE DRAWINGS

FIG. 1 is a flowchart for developing gradation according to the present invention.

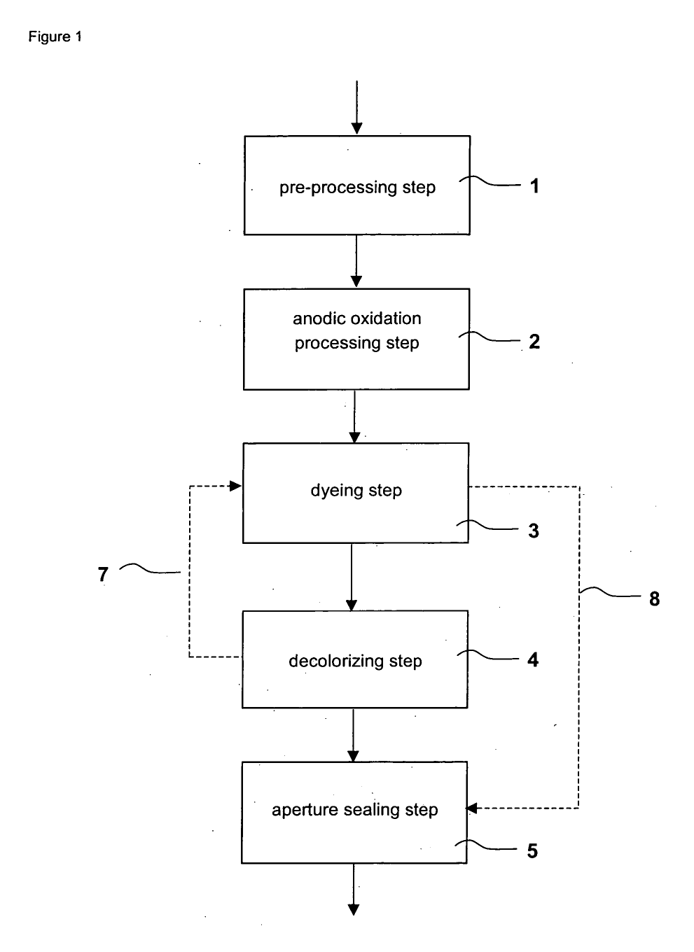

FIG. 2 illustrates a first gradation method of the dyed portion.

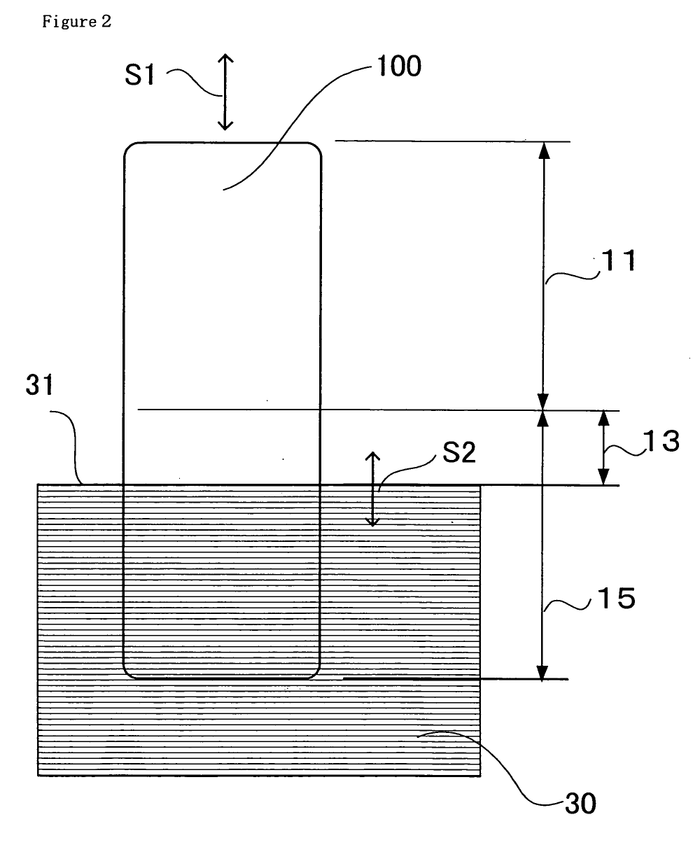

FIG. 3 illustrates a second gradation method of the dyed portion.

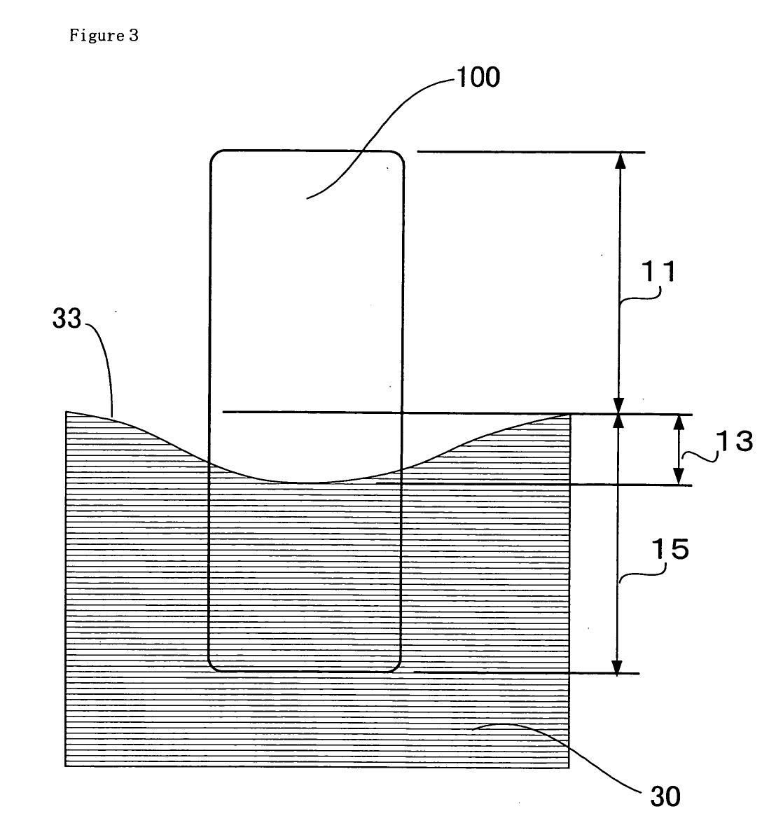

FIG. 4 illustrated a third gradation method of the dyed portion.

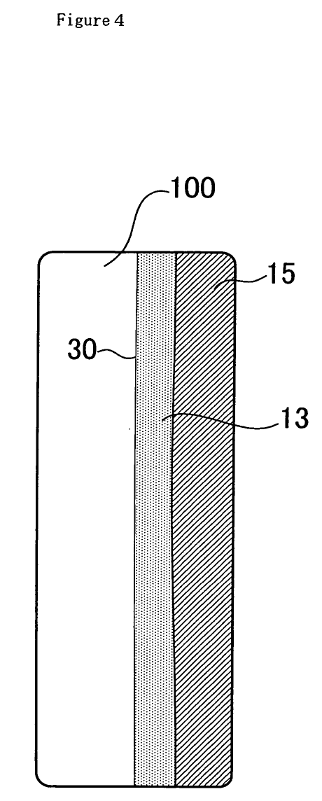

### DESCRIPTION OF REFERENCE NUMERALS

1 pre-processing step
2 anodic oxidation processing step
3 dyeing step
4 decolorizing step
5 aperture sealing step
7 dotted line arrow
8 dotted line arrow
11 non-decolorize portion
13 gradation portion
15 decolorize portion
30 solution of decolorize agent
31 liquid surface
33 waved surface
100 work

1) In a decoration method of dyeing aluminum including an anodic oxidation film processing, a dyeing step and an aperture sealing step,
a decoration method by anodic oxidation film processing characterized in adding, between the dyeing step and the aperture sealing step, a decolorizing step for adjusting the degree of decolorize subsequent to the dyeing step by immersing a work into a solution of decolorize agent and sequentially changing the depth of immersion, thereby providing gradation expression by continuous tones in the degree of decolorize.

2) In a decoration method of dyeing aluminum including an anodic oxidation film processing, a dyeing step and an aperture sealing step,
a decoration method of anodic oxidation film processing characterized in adding, between the dyeing step and the aperture sealing step, a decolorizing step of spraying a solution of decolorize agent on a work subsequent to the dyeing step for making the degree of decolorize by the solution of decolorize agent in continuous tones, thereby providing gradation expression.

3) In a decoration method by dyeing aluminum including an anodic oxidation film processing, a dyeing step and an aperture sealing step,
a decoration method by anodic oxidation film processing of claim 1 or 2, wherein adhesive characteristic of a solution of decolorize agent on the surface of the work is improved by mixing a viscosity increasing agent with the solution of decolorize agent or by mixing a wetting agent impregnated with or attaching the solution of decolorize agent.
